(19) United States
(12) Patent Application Publication
(10) Pub. No.: US 2008/0127712 A1
(43) Pub. Date: Jun. 5, 2008

(54) In-Situ Calibration Verification Device and Method for Electromagnetic Flowmeters

(76) Inventor: Roger Baker, Cambridge (GB)

Correspondence Address: WELSH & FLAXMAN LLC, 2000 DUKE STREET, SUITE 100, ALEXANDRIA, VA, 22314, US

(21) Appl. No.: 11/667,769

(22) PCT Filed: Nov. 15, 2005
(86) PCT No.: PCT/GB2005/004399

§ 371 Date: Oct. 3, 2007

(30) Foreign Application Priority Data
Nov. 15, 2004 (GB) 0425186.4

(51) Int. Cl. G01F 25/00; G01F 1/58; G01N 27/74

(52) U.S. Cl. 73/1.16; 73/861.12; 324/204

(57) ABSTRACT

An electromagnetic flowmeter calibration verification device for a flow tube comprises a first electrode, attachable to the flow tube, for transmitting, in use, a test current into the flow tube, and a second electrode, attachable to the flow tube, for receiving, in use, the test current transmitted through the flow tube. The device is arranged such that, in use, the test current, when passing from one electrode to another, passes through liquid in the flow tube. The device further comprises a third electrode, attachable to the flow tube, such that, in use, a voltage generated due to current distribution within the flow tube when the test current is passing within the tube is determined, and means for generating an output signal to a user if the voltage generated is outside a predetermined range. A method of verifying the calibration of an electromagnetic flowmeter for a flow tube is also provided.

The present invention relates to the verification of the calibration of electromagnetic flowmeters (EMFMs) particularly in situ in the field or in an industrial plant.

Electromagnetic flowmeters (EMFM) are used to measure the flow rate of a liquid by measuring the effects of passing the fluid through a magnetic field. When a liquid flows through a tube or pipe across which a transverse magnetic field is applied, voltages and currents are generated in the liquid due to the motion of the liquid in the magnetic field. Magnetic coils generate the field required, and it is essential that these coils, together with the tube itself, are designed in order that influences such as upstream disturbances affect the flowmeter as little as possible. The coils are typically excited using sinusoidal AC or, more commonly, square wave excitation currents, or a combination of these.

An insulating liner (typically formed of neoprene, polyurethane, PTFE or ceramic material) can be inserted or formed integrally within the tube in order to avoid the small voltages generated being shorted out through the conducting tube. The flowmeter generally consists of a sensor head (or primary element) and transmitter (or secondary element) linked to the sensor head, and in addition to the magnetic coils and core, electrodes are positioned so as to pass through the insulating liner. These measure the voltages generated in order to indicate the volumetric flow rate of the fluid through the tube. The electrodes are typically made of non-magnetic metals such as stainless steel, platinum-iridium, tantalum or hastelloy. The square wave excitation current is efficient in providing a sufficient dwell period at two different field excitations to allow any spurious voltages generated to decay—the flow signal can then be obtained as a difference between these two levels.

The relationship between the voltage generated, ΔU, and the mean fluid velocity Vₘₑₐₙ for the above-described meters approximates closely to a linear relationship in which:

ΔU=SBDVₘₑₐₙ

where S is the sensitivity and is dependent on the magnetic field shape and flow profile, B is the magnetic flux density and D is the pipe diameter. For a circular pipe, this relationship will be precisely valid if the magnetic field is uniform and the flow profile is axisymmetric; if this is the case then S=1, and the meter gives a signal proportional to the mean velocity or volumetric flow rate. A “weight function” shows how the velocity, at any point in the cross-section of the tube “weights” the signal, that is, it indicates how the EMFM's signal is affected by the detailed geometry of the magnetic field and the flow tube. EMFMs typically have around 0.5% uncertainly in the flow rate.

Such flowmeters are commonly used in industry to measure the rate of flow of a liquid. In some cases there are requirements for such flowmeters to be recalibrated at regular intervals. This recalibration process usually involves removing the flowmeter from the flow circuit or process plant in which it is installed, substituting it with an alternative meter, transporting it to an off-site calibration facility, and then recalibrating, returning and reinstalling the flowmeter. This entire process is expensive, as is the process of actually recalibrating the flowmeter at the calibration facility.

There exists within certain industries, such as the water industry, a need to verify the calibration of meters for pipes through which a liquid flows, in order to check whether calibration is actually required and hence delay the need for recalibration.

Upstream and (to a lesser degree) downstream installations, such as pipe work fittings, will detract from the calibration of the meter, and changes in the upstream pipe work condition caused by deposits, pipe roughening and so on, may change the reading of the meter from the initially installed values. Typically, an error of approximately 1% may occur for fittings separated from the meter by 10 D of straight pipe. A pipe fitting at least 3 D downstream of the electrode plane should not affect the response.

Various EMFM verification devices which use transmitter testing are known in the art. In these devices, simulators inject standard signals into the EMFM electronics and the output signals are detected to ensure that these are correct, in order to test the accuracy of the electronics. Devices are also known which test the electrical circuits relating to field coil excitation, the magnetic field, electrodes, cables and/or earth shields.

A further known device checks the control system via simulation as described above, and verifies the integrity of the amplifier and the current and frequency outputs; there is also a routine in each case for checking the balance of the electrode signals. The measures used do not, however, guarantee the integrity of the internal surfaces of the flow tube, nor do they sense flow changes.

Existing verification devices therefore only monitor the integrity of the electric circuits and check the magnetic field through its inductance and resistance or by direct measurement. These previous devices fail to allow for changes in the flow tube due, for example, to changes in the tube conditions or deposit build-up in the tube. Known devices can be employed to sense damage such as a definite break in the liner, for example a hole in the liner such that the electronics/meter construction is exposed to water, by measuring a change in resistance. However, such sensing techniques fail to sense damage which has not caused a definite break in the liner, for example due to blistering of, or other damage to, the liner.

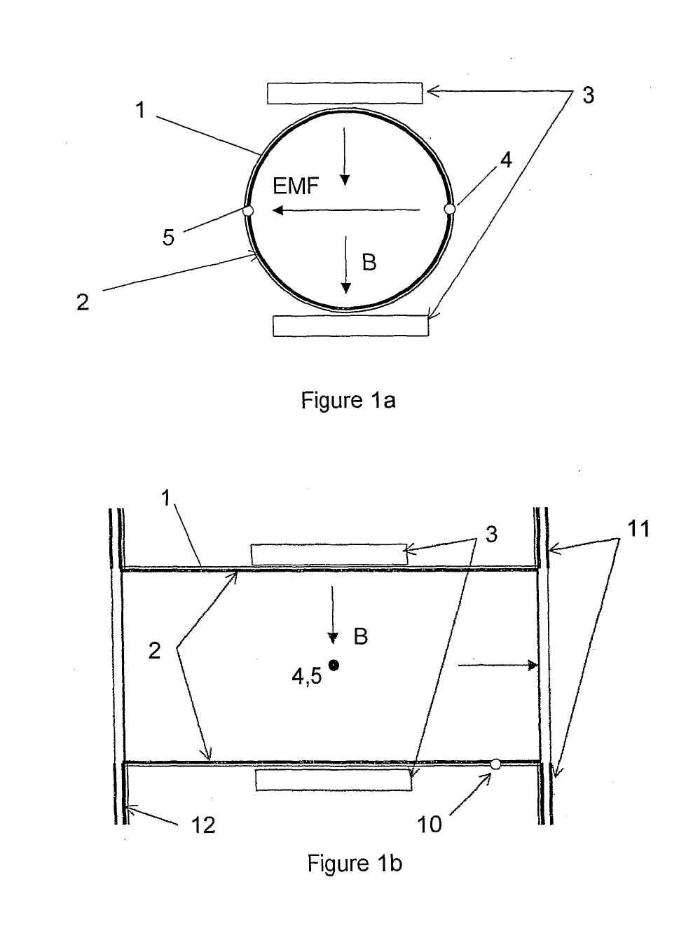

Cross-sectional and longitudinal views of a conventional EMFM are shown in FIGS. 1a and 1b, respectively.

The present invention seeks to overcome the above problems and verify that the EMFM calibration is retained, by making use of a sensing technique which indicates any changes within the tube structure or, for example due to the build-up of deposits.

According to the present invention there is provided an electromagnetic flowmeter calibration verification device for a flow tube, the verification device comprising:

a first electrode, attachable to the flow tube, for transmitting, in use, a test current into the flow tube; and

a second electrode, attachable to the flow tube, for receiving, in use, the test current transmitted through the flow tube,

wherein the device is arranged such that, in use, the test current, when passing from one electrode to another, passes through liquid in the flow tube, the device further comprising:

a third electrode, attachable to the flow tube, such that, in use, a voltage generated due to current distribution within the flow tube when the test current is passing within the tube is determined; and

means for generating an output signal to a user if the voltage generated is outside a predetermined range.

The present invention further provides a method of verifying the calibration of an electromagnetic flowmeter for a flow tube, the method comprising the steps of:

transmitting a test current into the flow tube via a first electrode; and

receiving the transmitted test current via a second electrode;

wherein the test current, when passing from one electrode to another, passes through liquid in the flow tube, the method further comprising the steps of:

determining a voltage generated, in use, due to current distribution within the flow tube via a third electrode, when the test current is passing within the tube; and

indicating to a user if the voltage generated is outside a predetermined range.

The verification device may further comprise a set of magnetic coils for producing, in use, a magnetic field inside the flow tube.

The magnetic field sensor may comprise a search coil.

The magnetic field sensor may measure the inductance of one or more of the magnetic coils.

The magnetic field sensor may include one or more measuring points positioned around the flow tube.

The verification device may further comprise electronics for conducting, in use, a routine for applying the test current at desired intervals and for a required period of time.

The verification device may further include means for combining the virtual current and magnetic field signals sensed, and means for determining changes in a weight function.

The verification device may further comprise additional electrodes arranged to sense, in use, at a variety of angles relative to the magnetic field.

The device may include one or more additional sets of magnetic field coils in order to provide different aspects of a flow profile.

One or more additional pairs of electrodes may be spaced axially along the flow tube.

Local sensing means may also be employed, in order to determine details of a flow profile at various points around the tube wall.

The present invention makes use of an alternative equation for describing the characteristics of the signals measured by the EMFM:

ΔU=∫∫∫_{flow tube volume}V·Wdτ (1)

where V is the vector velocity distribution within the flow tube, W=B×jᵥ is the “weight vector”, and jᵥ is the current distribution which would exist in the flow tube if a unit current were passed into the tube through one electrode and out through another. This parameter is known as the “virtual current” as it does not occur during normal operation of the EMFM. The change in the virtual current distribution is measured at a third electrode, and may be of the same order as any change which has occurred in the weight function.

If W is kept constant then the response of the flowmeter will be unchanged for constant flow profile, and if W is as uniform as possible then the response will be little affected by changes in flow profile brought about by changes which might occur in the pipe work due to use, for example, due to deposit build-up.

In the present invention, by ensuring the constancy of the virtual current jᵥ and the magnetic flux density B, the necessity for recalibration can be reduced; if it can be shown that the induced virtual current is unchanged, the likelihood that the inside of the pipe has not changed can be shown with a greater degree of certainty. The virtual current is monitored by measuring the “virtual voltage” corresponding to that current with a voltmeter, and the concept of the “virtual voltage” will be described in further detail on page 8 of this specification. Any change which does occur which lies outside an acceptable limit can be used to assess the likely change in the distribution and size of the weight function, and hence whether re-calibration is required.

The present invention will now be described with reference to the accompanying drawings, in which:

FIG. 1a shows an end view of a conventional electromagnetic flowmeter;

FIG. 1b shows a longitudinal sectional view of the device of FIG. 1a;

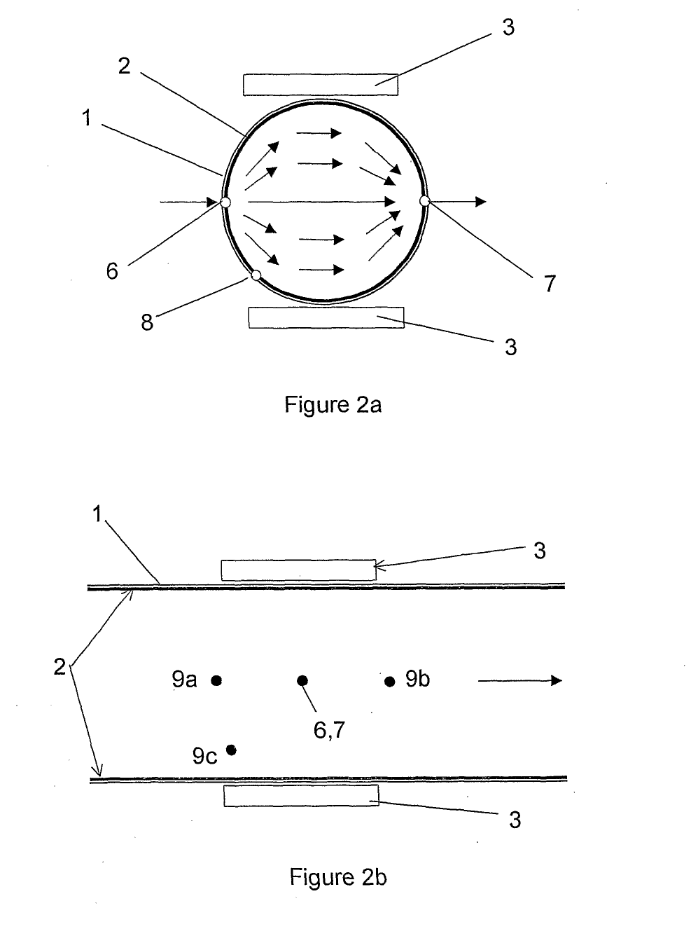

FIG. 2a shows an end view of an electromagnetic flowmeter in accordance with the present invention;

FIG. 2b shows a longitudinal sectional view of the device of FIG. 2a;

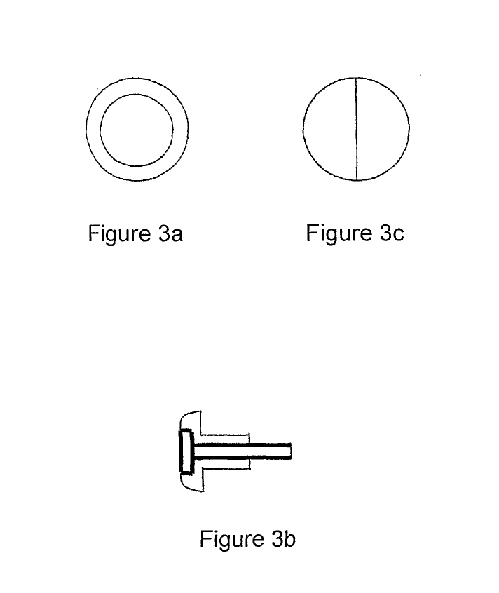

FIGS. 3a to 3c show examples of electrode configurations which can be used in the present invention; and

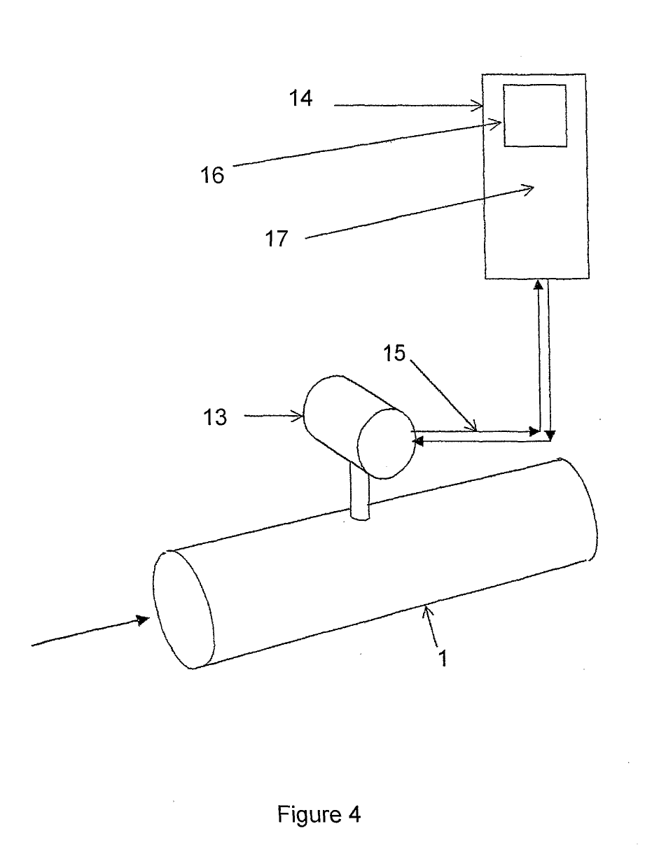

FIG. 4 illustrates the incorporation of a supplementary device into the electromagnetic flowmeter of FIG. 2.

As mentioned previously, when a liquid flows through a tube or pipe across which a transverse magnetic field is applied, voltages and currents are generated in the liquid due to the motion of the liquid in the magnetic field. The tube is lined with an insulating material, to prevent the voltages being shorted out through the conducting tube.

FIG. 1a shows a cross-section of a conventional EMFM comprising a tube 1 with such a liner 2. Typically two field coils 3 create a magnetic field with a flux density, B, which varies across and along the tube. The motion of the fluid with velocity, V, through this field results in the generation of voltages and currents. The voltage is measured between electrodes 4 and 5 shown in FIG. 1a. FIG. 1b shows a longitudinal section of the tube 1 with the liner 2, and also illustrates one of the electrodes 4 or 5, the field coils 3 and the direction of fluid flow along the pipe.

If the flowmeter is very long, and the field coils 3 are very large, so that the magnetic field is essentially uniform throughout the meter, then if the pipe upstream is of sufficient length to ensure that the flow profile in the fluid is axisymmetric, the voltage generated can be shown to be

ΔU=BDVₘₑₐₙ (2)

where B is the flux density, D is the pipe diameter and Vₘₑₐₙ is the mean velocity in the pipe. However, if the field coils are of finite size, or the liner is of finite length, then a sensitivity coefficient S is required which is less than unity, giving the revised relationship

ΔU=SBDVₘₑₐₙ (3)

In order to identify the effect of the flow in each part of the flowmeter tube, a “weight function” has been developed. This relates the importance of the velocity at each part of the cross section of the tube to the final signal. In its fullest form the equation for the EMFM can be written as:

ΔU=∫∫∫_{Flow tube volume}V·Wdτ (4)

where V is the vector velocity distribution within the flow tube, W is the weight vector distribution within the flow tube and is given by:

W=B×jᵥ (5)

B (in bold) being a vector, and it can be shown that for an ideal flowmeter, one which measures the mean velocity regardless of the velocity profile in the flow tube:

∇×W=0 (6)

### The symbol jᵥ represents the virtual current which would result if a unit current were injected into one of the sensing electrodes and removed from the other one.

FIG. 2a shows an EMFM according to the present invention comprising a flow tube 1 with an insulating liner 2, as previously described. A pair of field coils 3 is shown, however one or more additional sets of field coils can be employed, such that different aspects of the flow profile are provided.

Electronic circuitry, including an amplifier, is also provided, along with electronic components which inject and measure the test current and virtual voltage, and these components can be integrated into the EMFM. Such additional components are shown in FIG. 4.

The current injection from an electrode can be at the same frequency or with the same wave pattern as for the field excitation. However, in some cases it is advantageous to use a higher frequency and a sinusoidal wave. The frequency can lie in the hertz or kilohertz ranges. Operation at these frequencies may allow testing without interrupting the flowmeter functions.

FIG. 2a shows the current entering one electrode 6, and spreading out over the cross section of the tube 1 and leaving at a second electrode 7. There is also a distribution of the current longitudinally along the tube 1. Under normal operation this current does not exist, but is a mathematical concept which contributes to the weight vector, W.

For most flows, the velocity (apart from turbulence eddies) can be considered to be rectilinear, and the integral then becomes one over the cross section of the tube where:

ΔU=∫∫_{Flow tube cross-section}rV_{z}(r,θ)W′(r,θ)dθdr (7)

where V_{z} is the axial velocity component at r and θ, where r is the radial coordinate from the axis of the pipe and θ is the azimuthal coordinate, and where:

$${W}^{′} ( r , θ ) = {\int }_{- ∞}^{∞} {W}_{z} ( r , θ ) d z \qquad ( 8 )$$

where W_{z} is the z component of the weight vector and W′(r,θ) is sometimes referred to as the weight function.

In the present invention, the signal sensed is dependent on the constancy of the integration region and of the weight vector. Previous methods of obtaining a verification of the meter performance have used the constancy of the magnetic field. In the present invention, however, a change in the virtual current is used to indicate that the integration region and the integrand have changed. A magnetic field is preferably produced inside the flow tube, however the virtual voltage can be determined without the presence of such a magnetic field.

To achieve this, the operation of the EMFM is modified to incorporate periodic insertions of a current between the sensing electrodes or other electrodes to simulate the virtual current, and electronics can be employed to systematically apply the test current at desired intervals, for desired periods of time, in order to provide a testing routine which specifically suits the system in which the flowmeter is being employed. The integrity of that current is measured by measuring the voltage at one or more additional electrodes 8. The voltage thus created will hereafter be referred to by the term “virtual voltage”. It is important to note that the liquid does not necessarily have to be flowing during the verification procedure.

In FIG. 2a the current is injected at a first electrode 6 and leaves from a second 7, and a third electrode 8, which could form part of a segmental electrode, provides the measure of the voltage and is used to check whether this has changed from initial manufacture or insertion of the meter. One or more of these electrodes is typically used for sensing change in the voltage created by the virtual current. The voltage should be measured at one or more points which are preferably as sensitive to change as possible.

The magnetic field sensor used in the EMFM of the present invention can take an inductance measurement of one or more of the magnetic coils, however a direct field measurement is preferably used.

In FIG. 2b some possible positions of the sensing electrodes for the measurement of the virtual voltage are shown. Thus the electrode at position 9a is upstream and the electrode at position 9b is downstream of the electrodes 6 and 7 in the plane of symmetry. Thus, one or more sensing electrodes can be employed and arranged at different angles to the magnetic field.

While the electrode design may be conventional, it may be advantageous to segment the electrodes as illustrated in FIGS. 3a-c. By so doing, it may be advantageous to inject the current through one segment and to use the other to measure the voltage. For instance, in FIGS. 3a and 3b, an inner portion of the electrode is used to inject the current, while the voltage can be measured via the outer portion, this outer portion being electrically insulated from the inner portion. As shown in FIG. 3c in an alternative example, the electrode can be split into two portions of a predetermined size, these portions again being insulated from one another.

Making use of segmental electrodes as shown in FIGS. 3a-c, it is advantageous to inject the current through one segment and measure the voltages between the other segments on the two electrodes and also between the two segments of one or both electrodes. In this way the voltage between the two electrodes can be normalized by the voltage between segments of one or both electrodes. This essentially allows changes in the virtual current distribution to be obtained without effects from changes in the conductivity of the liquid. This allows the invention to be used with two electrodes, provided that at least one of these is a segmental electrode.

It may be advantageous to segment the electrodes in other ways than shown in FIGS. 3a-c and in more than two parts. Thus a pair of electrodes segmented into three sections allow enhanced sensing of voltage drops between segments and allow the current to be injected into a segment that is not used for voltage measurement.

Alternatively, segmental electrodes are used, for example for electrodes 6 and 7 and also for other electrodes used to inject or remove the virtual current.

In some existing commercial flowmeters, an electrode 10 is used to provide an earth contact with the liquid in the pipe, as shown in FIG. 1b. It may be advantageous to use this electrode as a third electrode or to use it together with an additional electrode in the present invention, in order to measure the voltage created by the virtual current against earth. Additionally, it is not uncommon for EMFMs to be installed with earth plates 11 between flanges 12 (also shown in FIG. 1b). It may be advantageous, if this is the case, to use the earth plate 11 as one side of the potential being measured at additional electrodes, when employing the present invention.

Electrodes can also be specifically positioned across a segment of the tube.

For example, two electrodes positioned below and at 45° to the horizontal and either side of the vertical centre line of the flowmeter of FIG. 2a, as well as providing a measure of the virtual voltage between them, or between each one and earth (as described above), can be used to obtain a flow signal. This is weighted towards the flow in the lower part of the pipe. The meter can employ a look-up table of the ratio of this signal to the diametral signal for various Reynolds numbers. In the case where the ratio diverges from the look-up table by a predetermined amount, then the flow profile may have changed and a warning can be given. Such a look-up table can, for example, be constructed to give the changes resulting from the meter being installed downstream of a bend, a valve, etc. Signal analysis of the fluctuation in the signals due to turbulence can then be used to add to the information as to the installation.

In one example of the present invention, electrodes 6 and 7, situated at each end of the diameter as shown in FIG. 2a, are the electrodes through which the virtual current is injected and removed, and one sensing electrode at position 9a, 9b, 9c or elsewhere senses the change in the virtual voltage compared with one of the electrodes 6, 7 or with some other point in the tube 1.

Further sensing is achieved by inserting the current through, for example, electrode 6, and removing it from, for example, electrode 8 in addition to the previous insertion and removal through electrodes 6 and 7. The resulting voltages across all pairs of electrodes, which can be normalized using the voltage between electrode segments, may be used to sense for changes in other areas of the flow tube, and to identify where in the tube a problem lies.

In a further example, electrodes 6 and 7 are the electrodes through which the virtual current is injected and removed, and pairs of sensing electrodes at 9a, 9b, or 9c positioned at each end of the diameters or elsewhere sense the change in the virtual voltage between each pair.

In yet a further example, a pair of electrodes at position 9a can be used as sensing electrodes and a pair of electrodes at position 9b as virtual current injection electrodes. This can then be reversed and the electrodes at 9b can be used as sensing electrodes and those at 9a as virtual current injection electrodes.

Alternatively, the time of transit between electrodes at positions 9a and 9b might be used in a correlation mode to give a further check on the integrity of the EMFM signals. In applying such a correlation mode, the correlation is between the flow signal (as opposed to the virtual current signal) sensed between, for example, two pairs of diametral electrodes at two positions in a plane that is parallel to the axis of the meter, but displaced axially from one another along the pipe within the ambit of the magnetic field.

It should be noted that none of the above options necessarily require that the electrodes are at opposite ends of a diameter. Electrode cleaning may be employed in order to keep the electrodes clean enough to undertake the measurements.

Changes to the flow tube may have a greater effect on the virtual voltages than on the flow signal. In any flow tube, there will exist an optimum position for the virtual voltage sensing electrodes 8 to give the most sensitive indication of change in W′, and the sensing electrodes 8 may therefore be placed at these positions.

As shown in FIG. 4, in a further example of the EMFM set-up according to the present invention, the EMFM constitutes a primary element of the device, including the electrodes as previously described, and a secondary transmitter device 13 coupled thereto. In this case, electronic components for inserting the test current and measuring the virtual voltage are provided separately in a removable supplementary element 14 that is coupled to the EMFM via connecting leads 15. The supplementary element 14 can be a hand held device, and has a screen 16 which communicates instructions and information to a user, and a keyboard 17 or similar input device to allow communication with the EMFM.

The virtual voltage (or normalised virtual voltage) measured provides, for example, details of which pair of electrodes has detected a problem in the case where more than two electrodes are used. The information is signalled through, for example, radio links fed back to the user or to a manufacturer with error messages. Such messages optionally include information relating to the integrity of the wiring, the ground insulation and/or the amplifier gain.

In one example of the present invention, a detector is provided as a part of the verification device for determining changes in the weight function which uses the voltage and magnetic field signals sensed, with suitable software, to deduce the weight function or changes in the weight function based on the signals sensed.

It is possible to manufacture a flowmeter the electrodes of which make a capacitive, rather than conductive, contact with the liquid in the tube, for example using a ceramic liner and positioning the capacitive electrodes behind part of the ceramic liner.

Signal analysis by known techniques also allows identification of any changes from the initial flowmeter “fingerprint” taken at manufacture or installation, and to identify the causes thereof. The invention can also employ remote sensing techniques to allow verification of results at a distance. One method of implementing this is via drop and drag computer systems in the receiving company. This type of system is preferably accessible via the internet, such that a known user is able to implement the in situ verification test and receive the results thereof, or access a database of previously stored or continually updated results, via e-mail or a specific website. The present invention can therefore be employed in a user-friendly and easily accessible manner.

The present invention therefore provides a simple and unintrusive in situ calibration verification test, which is effective and far more cost efficient than previous recalibration tests, since it reduces or eliminates the need for re-calibration. The EMFM verification device of the present invention is used to perform a test which responds to changes taking place within the flow tube, as these affect the pattern of the virtual current.

1. An electromagnetic flowmeter calibration verification device for a flow tube, the verification device comprising: a first electrode, attachable to the flow tube, for transmitting, in use, a test current into the flow tube; and a second electrode, attachable to the flow tube, for receiving, in use, the test current transmitted through the flow tube, wherein the device is arranged such that, in use, the test current, when passing from one electrode to another, passes through liquid in the flow tube, the device further comprising: a third electrode, attachable to the flow tube, such that, in use, a voltage generated due to current distribution within the flow tube when the test current is passing within the tube is determined; and means for generating an output signal to a user if the voltage generated is outside a predetermined range.

2. A verification device according to claim 1, the device further comprising a set of magnetic coils for producing, in use, a magnetic field inside the flow tube.

3. A verification device according to claim 2, the device further comprising: a magnetic field sensor for determining the size of the magnetic field; and means for generating an output signal to a user if the magnetic field size sensed is outside a predetermined range.

4. A verification device according to claim 3, wherein the magnetic field sensor includes one or more measuring points positioned around the flow tube.

5. A verification device according to claim 1, wherein the device further comprises electronics for conducting, in use, a routine for applying the test current at desired intervals and for a required period of time.

6. A verification device according to claim 1, wherein the device further includes: combining means for combining the voltage and magnetic field signals sensed; and a detector for determining changes in a weight function.

7. A verification device according to claim 2, wherein the device further comprises additional electrodes arranged to sense, in use, at a variety of angles relative to the magnetic field.

8. A verification device according to claim 2, wherein the device includes one or more additional sets of magnetic field coils, in order to provide different aspects of a flow profile.

9. A verification device according to claim 1, wherein one or more additional pairs of electrodes are spaced axially along the flow tube.

10. A verification device according to claim 1, wherein local sensing means are employed, in order to determine details of a tube profile at various points, around the tube wall.

11. A verification device according to claim 3, wherein the magnetic field sensor comprises a search coil.

12. A verification device according to claim 3, wherein the magnetic field sensor measures the inductance of one or more of the magnetic coils.

13. A verification device according to claim 1, the device further comprising means for providing the test current and means for measuring the voltage generated, wherein the current providing means and measuring means form an integral part of the flowmeter.

14. A verification device according to claim 1, the device further comprising means for providing the test current and means for measuring the voltage generated, wherein the current providing means and measuring means are housed separately from the flow tube and are detachably coupled thereto.

15. A method of verifying the calibration of an electromagnetic flowmeter for a flow tube, the method comprising the steps of: transmitting a test current into the flow tube via a first electrode; and receiving the transmitted test current via a second electrode; wherein the test current, when passing from one electrode to another, passes through liquid in the flow tube, the method further comprising the steps of: determining a voltage generated, in use, due to current distribution within the flow tube via a third electrode, when the test current is passing within the tube; and indicating to a user if the voltage generated is outside a predetermined range.

16. A method according to claim 15, the method further comprising the step of producing a magnetic field inside the flow tube.

17. A method according to claim 16, the method further comprising the steps of: determining the size of the magnetic field via a magnetic field sensor; and indicating to a user if the magnetic field size sensed is outside a predetermined range.

18. A method according to claim 17, wherein the magnetic field sensor includes one or more measuring points positioned in the flow tube.

19. A method according to claim 15, wherein the method further comprises the step of applying the test current at desired intervals and for a required period of time.

20. A method according to claim 17, wherein the method further comprises the steps of combining the voltage and magnetic field signals sensed, and determining changes in a weight function.

21. A method according to claim 15, wherein the method further comprises sensing at a variety of angles relative to the magnetic field.

22. A method according to claim 15, wherein different aspects of a tube flow profile are provided via one or more sets of magnetic field coils.

23. A method according to claim 15, wherein one or more additional pairs of electrodes are spaced axially along the flow tube.

24. A method according to claim 15, wherein the method further comprises the step of determining details of a tube flow profile at various points around the tube wall.

25. A method according to claim 17, wherein the magnetic field sensor comprises a search coil.

26. A method according to claim 17, wherein the magnetic field sensor measures the inductance of one or more of the magnetic coils.

27. A method according to claim 15, wherein means for providing the test current and means for measuring the voltage generated form an integral part of the flowmeter.

28. A method according to claim 15, wherein means for providing the test current and means for measuring the voltage generated, are housed separately from the flow tube and are detachably coupled thereto.
